(19) United States
(12) Patent Application Publication
(10) Pub. No.: US 2020/0320493 A1
(43) Pub. Date: Oct. 8, 2020

(54) SYSTEMS AND METHODS FOR ACCOUNT MANAGEMENT

(71) Applicant: Wells Fargo Bank, N.A., San Francisco, CA (US)

(72) Inventors: Abraham Drucker, San Francisco, CA (US); Khushbu Katariya, Dublin, CA (US); Timothy R. Knowlton, Mill Valley, CA (US); Shelby K. Morita-Fowler, Alameda, CA (US); Brian M. Pearce, Pleasanton, CA (US); Dana Roytenberg, San Francisco, CA (US); John T. Wright, Benicia, CA (US)

(21) Appl. No.: 16/376,571

(22) Filed: Apr. 5, 2019

(51) Int. Cl. G06Q 20/10; G06Q 40/06

(52) U.S. Cl. CPC G06Q 20/102; G06Q 40/06

(57) ABSTRACT

A method for managing accounts using an account management system comprising an allocation management circuit and a transaction management circuit. The method includes identifying, by the allocation management circuit, funds to be allocated; determining, by the allocation management circuit, an allocation for the funds amongst a plurality of allocation options comprising (i) a pending account for a payee, and (ii) a projected account, based on a priority for the pending account for the payee and a priority for the projected account; and implementing, by the transaction management circuit, the allocation for the funds

### TECHNICAL FIELD

Embodiments of the present disclosure relate generally to the field of account management.

### BACKGROUND

Managing accounts and allocating funds between allocation options such as paying off pending payments or current balances, providing for incoming or pending expenses, and directing incoming funds can involve certain challenges. Certain pending payments to payees may be prioritized over others for a variety of reasons. For example, certain payees for whom payments are pending may be prioritized, or certain pending payment amounts or payment types may be prioritized, and funding for upcoming or projected expenses may preferably be accounted for. Allocation of funds may also take into account investment opportunities and available credit sources. A manager of the funds or a payor may have certain specific preferences regarding the above or other factors, and the complexities involved in allocating funds accordingly may be challenging.

### SUMMARY

One example embodiment relates to a method for managing accounts using an account management system that includes an allocation management circuit and a transaction management circuit. The method includes identifying, by the allocation management circuit, funds to be allocated; determining, by the allocation management circuit, an allocation for the funds amongst a plurality of allocation options comprising (i) a pending account for a payee, and (ii) a projected account, based on a priority for the pending account for the payee and a priority for the projected account; and implementing, by the transaction management circuit, the allocation for the funds.

Another example embodiment relates to a method for managing accounts using an account management system including one or more processors. The method includes: identifying, by the one or more processors, funds to be allocated; determining, by the one or more processors, a plurality of pending accounts for a respective plurality of payees; determining, by the one or more processors, an allocation for the funds amongst the plurality of pending accounts, based on respective priority scores for the pending accounts; and implementing, by the one or more processors, the allocation for the funds.

Another example embodiment relates to a system for managing accounts. The system includes a processor and a data storage medium storing processor-executable instructions that, when executed by the processor, cause the processor to: identify funds to be allocated; determine an allocation for the funds amongst a plurality of allocation options comprising (i) a pending account a payee, and (ii) a projected account, based on a priority for the pending account for the payee and a priority for the projected account; and implement the allocation for the funds.

Various objects, aspects, features, and advantages of the disclosure will be readily understood by referring to the detailed description taken in conjunction with the accompanying drawings, in which like reference characters identify corresponding elements throughout. In the drawings, like reference numbers generally indicate identical, functionally similar, and/or structurally similar elements.

### BRIEF DESCRIPTION OF THE DRAWINGS

FIG. 1 is a schematic diagram of a financial management system including an account management system, according to an example embodiment.

FIG. 2 is a flow chart showing a method for managing accounts, according to an example embodiment.

FIG. 3. is a flow chart showing a method for managing accounts, according to an example embodiment.

FIG. 4. is a graph showing accounts and payment rules, according to an example embodiment.

FIG. 5 is a flow chart showing a method for managing accounts, according to an example embodiment.

FIG. 6 is a flow chart showing a method for selecting allocation options, according to an example embodiment.

### DETAILED DESCRIPTION

Various systems, methods, and apparatuses for facilitating account management are described herein. For example, the systems, methods, and apparatuses can be used to determine an improved or optimized allocation of funds for managing accounts. The accounts may include commercial, business, or personal accounts, and may include pending payments due to payees (e.g. to vendors, for goods or services provided, rendered, contracted for or promised, or to other debtors). The accounts may also include projected accounts or expenses, such as tax payments, payroll payments for employees or real estate related payments such as rent or mortgage payment. The systems, methods, and apparatuses described herein can be used to allocate funding (e.g., funding presently in an account, or incoming or expected funding) for those accounts based on prioritization of the accounts. For example, a payee may have a priority (e.g., the payee may be a vendor with whom it is important to maintain a positive relationship, and the payee may accordingly have a high priority), and the pending payment to the payee may have a priority based on the payee's priority. The pending payment's priority may also, or alternatively, be based on an amount owed or a payment type (e.g., a recurring payment or a one-time payment). An expense may also have a priority (e.g., a tax or payroll expense may have a high priority, while a real estate related expense having small delayed payment cost or late fee may have a low priority). The priorities may also be based on a fund manager or payor's preferences. The systems, methods, and apparatuses described herein can be used to allocate funds based on such priorities. The allocation of funds may also take into account investment opportunities available to a payor (e.g., opportunities to make an investment with a positive projected return on investment (ROI), or opportunities to make a payment to reduce or eliminate a recurring expense (e.g. pay down an interest-bearing loan)), available credit sources, and the payor's preferences regarding such options.

Furthermore, certain accounts may involve payments to payees, and the payees may have different payment rules. For example, different payees may have different delayed or late payment costs or penalties, or hard or unextendible payment deadlines, and it can be challenging to determine an appropriate allocation of funds that accounts for upcoming expenses and incoming funds. The payees may have different payment rules including one or more rules regarding delayed or late payment (including, for example, late fees, interest charged, deadlines that trigger the late fees or interest charges, and hard or unextendible deadlines). In some cases, it is preferable to delay payment to certain payees (even if such delay may mean incurring delayed payments costs) in order to better manage payments to other payees. For example, if, given current accounts and projected incoming funds and expenses, it is projected that there will be insufficient funds to meet a plurality of initial payment deadlines for a plurality of payees (or for multiple payments to a single payee), it may be best to select a particular payment to make at an initial deadline in order to minimize or lessen delayed payment costs. In some cases, credit may be available (e.g. via borrowing from a line of credit or from some other source) and it may or may not be less costly to make use of the credit to make a payment to a payee rather than to miss a payment deadline. There may also be investment opportunities available to a payor, and it may be more financially advantageous for the payor to invest in those opportunities rather than meeting a payment deadline. The systems, methods, and apparatuses described herein can provide for, among other things, improved management of accounts to minimize or lessen delayed payment costs, making use of available credit, determining when to invest or make an expense-reducing payment, and managing payments based on payee prioritization.

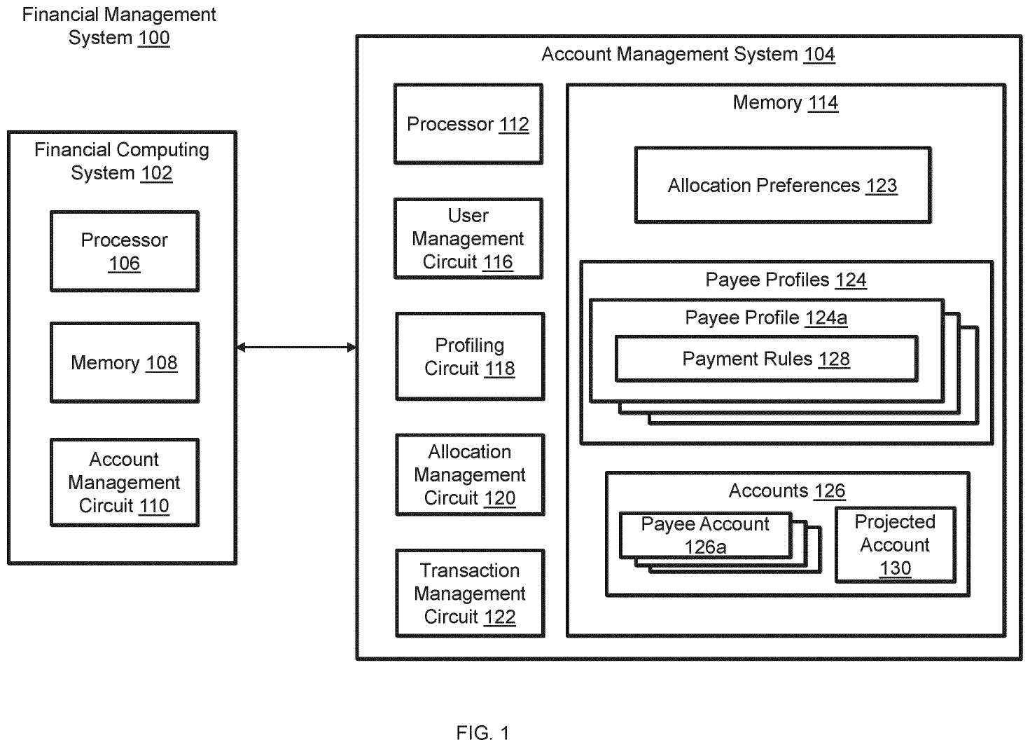

Referring now to FIG. 1, an illustration of a financial management system 100 is shown according to an example embodiment. The financial management system 100 can be implemented to facilitate account or payment management, to allocate funds, to determine payment schedules, and to implement allocation options. The financial management system 100 includes a financial computing system 102 and an account management system 104. Any of these components may be configured (e.g. via one or more network interfaces) to connect to each other and/or to an external device via a network. The network can provide communicable and operative coupling between the financial computing system 102, the account management system 104, and/or other components disclosed and described herein, to provide and facilitate the exchange of communications (e.g., data, instructions, requests, messages, values, commands). Accordingly, the network may include any network including wired (e.g., Ethernet) and/or wireless networks (e.g., 802.11X, ZigBee, Bluetooth, WiFi). In some embodiments, the network includes the Internet. In further embodiments, the network includes a proprietary banking network that can provide secure or substantially secure communications.

In some embodiments, the financial computing system 102 includes a computing system of a financial institution (e.g. of a bank, a credit provider, or another financial service provider). The financial computing system 102 may route funds between two or more financial accounts, and/or may route charges or invoices to appropriate parties. For example, the financial computing system 102 may debit a first financial account and may credit, or cause another system to credit, a second financial account. The financial accounts may include checking accounts, credit accounts, savings accounts, or any other type of financial account. The financial computing system 102 may perform financial transactions requested by the account management system 104, including routing of funds according to an allocation of funds determined by the account management system 104.

The financial computing system 102 may include a processor 106, a memory 108, and an account management circuit 110. The processor 106 may include one or more microprocessors, application-specific integrated circuits (ASIC), a field-programmable gate arrays (FPGA), etc., or combinations thereof. The memory 108 may include, but is not limited to, electronic, magnetic, or any other storage or transmission device capable of providing processor with program instructions. The memory may include magnetic disk, memory chip, read-only memory (ROM), random-access memory (RAM), Electrically Erasable Programmable Read-Only Memory (EEPROM), erasable programmable read only memory (EPROM), flash memory, or any other suitable memory from which a processor can read instructions. The memory 108 may include components, subsystems, data structures, modules, scripts, applications, or one or more sets of processor-executable instructions for implementing management of a financial account, including any processes described herein. The account management circuit 110 may be configured to access the memory 108, and to implement financial transactions such as debiting, crediting, and/or routing of funds from financial accounts. The account management circuit 110 may receive and implement transaction requests from the account management system 104. The account management circuit 110 may also implement certain security measures, such as verification of credentials received along with, or in parallel to, the transaction requests.

In some embodiments, the financial management system 100 may include the account management system 104. The account management system 104 may include a processor 112, a memory 114, a user management circuit 116, a profiling circuit 118, an allocation management circuit 120, and a transaction management circuit 122. The account management system 104 may provide for improved management of accounts to determine an allocation of funds based on account priorities. The account management system 104 may determine a payment schedule to minimize or lessen delayed payment costs, may make use of available credit, and may determine when to invest or make an expense-reducing payment. In some embodiments, the account management system 104 provides for these solutions by using the specific user management circuit 116, profiling circuit 118, allocation management circuit 120, and transaction management circuit 122 described herein.

The processor 112 may include one or more microprocessors, application-specific integrated circuits (ASIC), a field-programmable gate arrays (FPGA), etc., or combinations thereof. The memory 114 may include, but is not limited to, electronic, magnetic, or any other storage or transmission device capable of providing processor with program instructions. The memory may include magnetic disk, memory chip, read-only memory (ROM), random-access memory (RAM), Electrically Erasable Programmable Read-Only Memory (EEPROM), erasable programmable read only memory (EPROM), flash memory, or any other suitable memory from which a processor can read instructions. The memory 114 may include components, subsystems, data structures, modules, scripts, applications, or one or more sets of processor-executable instructions for implementing management of accounts, including any processes described herein. The user management circuit 116, the profiling circuit 118, the allocation management circuit 120, and the transaction management circuit 122 may be configured to access the memory 114 to perform operations described herein.

The memory 114 may store or include allocation preferences 123, payee profiles 124, and accounts 126. In some embodiments, allocation preferences 123, payee profiles 124, and accounts 126 are associated with a user profile managed by a user management circuit 116.

The allocation preferences 123 can include preferences for allocating funds to one or more allocation options. As used herein, the term allocation options can refer to accounts, parties, debts, investments, or other potential recipients of funds. The term allocation options can also refer to a set of specified recipients or destinations for funds, and can include specifications as to how or when the funds are to be allocated, or can include other specifications, such as those described herein. The allocation preferences 123 can be determined based on inputs received from the user management circuit 116, and can be used by the profiling circuit 118 as described herein (e.g., to determine payment rules 128 for payees) or by the allocation management circuit 120 for allocating funds.

The allocation preferences 123 can include preferences for allocating funds, including prioritization preferences, credit preferences, and investment preferences. The allocation preferences 123 may be default preferences, preferences specified by a payor (e.g., via the user management circuit 116), or a combination thereof.

The prioritization preferences may include preferences for prioritizing allocation options including payees (e.g. payees having payee profiles 124), pending payee accounts such as pending payments due to payees (e.g., payee accounts 126a), or projected accounts such as upcoming expenses (e.g., projected accounts 130). In some embodiments, the priorities may pertain to a type or category of allocation option. For example, the priorities may pertain to a category of payee (e.g., supplier, vendor, specific service provider, etc.), or to a category of payee account (e.g., first account with the payee, nth account with the payee, accounts have an amount owed in a predetermined range or at or above a predetermined threshold), or to a category of projected account (e.g., payroll, real estate related projected account, etc.). In some embodiments, the memory 114 may store a lookup table (LUT) or other data structure that specifies a respective number of priority points for each of the categories of the allocation options. The specified number of priority points may be used by the profiling circuit 118 in determining the priority of the allocation options (e.g., the specified number of priority points may be assigned to or added to the priority score of the allocation option being determined).

In some embodiments, the preferences for prioritizing allocation options may include setting a priority of one or more allocation options. The priority of the allocation options may indicate rules for the allocation options. For example, the priority may indicate whether the allocation option is a high priority or a low priority, where the high priority allocation options are addressed (e.g., funds are allocated to settle accounts in full or in part, or to have savings or a reserve of funds sufficient to address at least a portion of projected expenses) prior to the low priority allocation options. In some embodiments, the rules indicate that the high priority allocation options are to be fully addressed (e.g., funds are allocated to settle accounts in full, or to have savings or a reserve of funds sufficient to completely cover projected expenses) prior to addressing any low priority allocation options. For example, a payor may specify via such rules that certain projected expenses including tax expenses are high priority, that certain pending payee accounts are low priority, and that the tax expenses must be addressed in full prior to allocating funds to the payee accounts.

By way of further example, the priority for an allocation option may be a “must-pay” priority indicating that the allocation option must be addressed at a certain deadline (e.g., at a first deadline) for payment, and indicating that payments should not be delayed (e.g. past the first deadline). In some embodiments, the “must-pay” priority is a hard rule indicating that the allocation option must be paid at the deadline.

In some embodiments, the priority for the allocation option includes, or is, a priority score. The priority score may be a score on a set scale (e.g., on a 5 point scale, on a 10 point scale, on a 100 point scale, or on some other scale). In some embodiments, the priority score may be set via a GUI provided by the user management circuit 116, as described in more detail herein.

In some embodiments, the priority for the allocation option includes or is based on a rank of the allocation option relative to other allocation options. The rank may be used by the allocation management circuit 120 to order payments (e.g., a highest ranked allocation option may be paid first, a next-highest allocation option may be paid next, and so on).

In some embodiments, the allocation option may have an aggregate priority score based on a plurality of sub-priorities or sub-priority scores (e.g., based on a sub-priority score set by the payor, a sub-priority score based on a category of the allocation options, a sub-priority score based on (e.g., proportional to) an amount of an account or an aggregated amount due to a payee, a sub-priority score based on a priority rank, or a sub-priority score based on one or more rules in effect for the allocation option (e.g., the allocation option being a high priority or a “must-pay” allocation option)). In some embodiments, the memory 114 may store a data structure that specifies the sub-priority scores. The sub-priority scores may be used by the profiling circuit 118 in determining the priority of the allocation option (e.g., the specified sub-priority scores may be assigned to or added to the aggregate priority score of the allocation option).

In some embodiments, the allocation preferences include investment preferences. The investment preferences can relate to management of investment opportunities (e.g., opportunities to make an investment with a positive projected ROI, or cost reduction opportunities such as making a payment to reduce or eliminate a recurring expense (e.g. pay down an interest-bearing loan)). The investment preferences may specify rules or factors for determining whether to invest, how much to invest, when to invest, and where to invest funds.

In some embodiments, the investment preferences may specify allocating funds for an investment opportunity only if there are no pending accounts for payees or projected accounts that have yet to be addressed (e.g., have not had funds allocated to satisfy the accounts, in part or in full). In some embodiments, the investment preferences may specify allocating funds for an investment opportunity only if priorities for one or more (e.g., all) pending account for a payee and/or one or more projected accounts are below a reference threshold. For example, the reference threshold may be a predetermined threshold, or may be a threshold based on a priority of the investment opportunity. The priority of the investment opportunity may be based on an expected or projected ROI (e.g., an ROI percentage or an ROI absolute value), and may be based on a category of the investment opportunity. For example, the category may be one or more of a 401K investment, a retirement account investment, a mutual fund, an index fund, or a cost reduction opportunity (e.g., paying down an interest-bearing account or loan). The investment preferences may specify an importance of one of more of the categories of investment opportunities, and priorities for investment opportunities may be determined accordingly (e.g., based on the importance of the corresponding category).

In some embodiments, the allocation preferences include credit preferences, such as preferences regarding borrowing from one or more sources of credit (e.g., one or more liens of credit). For example, the credit preferences may specify borrowing funds only if there are insufficient funds to address pending accounts of a certain priority (e.g., must-pay accounts or accounts having a priority above a predetermined threshold). In some embodiments, the credit preferences may specify borrowing funds only if there are insufficient funds to address pending accounts of a certain priority before a payment deadline (e.g., before a first payment deadline, or before a final payment deadline). In other embodiments, the credit preferences may specify borrowing funds when it would be more profitable to do so relative to not borrowing funds (e.g., when it is determined that an allocation option that includes borrowing funds and allocating the funds (e.g., to an investment opportunity or to a pending account having an upcoming deadline associated with a delayed payment cost) is preferable or less costly than an allocation option that omits borrowing funds).

In some embodiments, the priorities discussed herein account for, at least in part, various factors or considerations, such as a number of pending or projected accounts, an amount of pending or projected accounts (e.g., an aggregate amount or individual amounts), a cost of delayed payment for accounts, or other factors or considerations (e.g., other factors or considerations discussed herein), and the allocation preferences 123 may reference such priorities. Thus the allocation management circuit 120 can allocate funds based on allocation preferences 123 and in doing so, can at least partially account for such considerations. In other embodiments, the allocation preferences 123 may not be directly based on such priorities, and may specify allocating funds based directly on at least some of the considerations discussed above (e.g., based directly on a number of pending or projected accounts, an amount of pending or projected accounts (e.g., an aggregate amount or individual amounts), a cost of delayed payment for accounts, or other factors or considerations). For example, the investment preferences may specify allocating funds for an investment opportunity based on a delayed payment cost for a pending account for the payee that would go unpaid should the investment opportunity be realized, and the allocation management circuit 120 may allocate funds accordingly, or the investment preferences may allocating funds for the investment opportunity based on a priority of a pending account which is based on a delayed payment cost for the pending account (e.g., based on a projected delayed payment cost of allocating funds to the investment opportunity instead of to the pending account, and thereby triggering the delayed payment cost).

Referring now to the payee profiles 124, the payee profiles 124 may include any number of payee profiles 124 (e.g., payee profiles 124a through 124n). The payee profiles 124 can correspond to any payee that the account management system 104 is configured to manage. For example, the payee profiles 124 can correspond to vendors (e.g., current vendors, projected vendors, potential vendors, or past vendors) that provide goods or services (e.g., to a party, entity, corporation, merchant, or individual for whom the account management system 104 is configured to generate an allocation of funds). The payee profiles 124 can correspond to debtors (e.g., current debtors, projected debtors, potential debtors, or past debtors), such as, for example, creditors to whom one or more payments are due, or to whom funds are owed. The payee profiles 124 can correspond to credit sources, such as a creditor that has extended or has offered to extend a line of credit, or who has otherwise made the line of credit available.

The payee profiles 124 can include payment rules 128 and can be associated with a priority. The profiling circuit 118 may determine the payee profiles 124 or any components thereof. The payment rules 128 may be determined based on the allocation preferences 123. For example, the allocation preferences 123 may specify rules for certain categories of payees, the payee profile 124a may fall within one of the categories, and the profiling circuit 118 may accordingly determine payment rules 128 for the payee profile 124a. In some embodiments, the payment rules 128 may be based on inputs or specification from the payor (e.g., submitted via a GUI provided by the user management circuit 116), and the profiling circuit 118 may accordingly determine the payment rules 128 based on the payor inputs or specifications.

In some embodiments, the payment rules 128 can include, or can be determined from, any rules, contracts, deals, regulations, agreements, or conditions of the corresponding payee (e.g. with regard to accounts due to or from the payee). In some embodiments, the payment rules 128 can include standard contracting terms or prices made available to the general public or to another group. The payment rules 128 can include one or more payment deadlines or other deadlines. The payment rules 128 can include one or more delayed payment costs or penalties, such as late fees or interest. The delayed payment costs may be associated with the one or more payment deadlines or other deadlines (e.g., may be triggered at or by one of the payment deadlines). The delayed payment costs may include interest (e.g. interest on an overdue account or on another account). The payment rules 128 may specify that certain payments, or payments falling within a certain payment category, are extendible or non-extendible payments. The payment rules 128 may include one or more minimum payments (e.g. non-extendible minimum payments). The payment rules 128 may specify fixed delayed payment costs that include fixed costs, that are percentage based (e.g. based on a principle, such as a principle borrowed from a line of credit, or based on an unpaid account or an overdue account), or that are based on partial payments made (e.g. a first delayed payment cost assuming a minimum payment is made, and a second delayed payment cost assuming the minimum payment is not made).

The payment rules 128 may specify discrete payment times, such as days, weeks, or months during which payment can be made. The payment rules 128 may treat payments made within the discrete payment times similarly (e.g., payments of a certain amount made at any point during a discrete payment time may have a similar or same effect with regard to triggering a delayed payment cost or satisfying a payment obligation). The discrete payment times may include a first period within which a payment is due (e.g. a payment for an account owed, that may not include delayed payment costs) and a second period within which a first delayed payment cost is triggered (e.g. following the first period). The discrete payment times may include further periods within which further delayed payment costs are triggered. The discrete payment times may include discrete borrowing times associated with respective borrowing costs (e.g., borrowing costs associated with a line of credit or other credit source).

The payee profiles 124 may also each include or be associated with a respective priority. The priority may indicate an importance of the payee, or an importance of making payments (e.g., timely payments) to the payee. The priority may be taken into account by the allocation management circuit 120 when determining an allocation of funds. The priority may include a rank (e.g. relative to one or more other payees) or priority score.

In some embodiments, the priority of the payees may be determined based on the allocation preferences 123 (e.g., based on one or more rules for determining priority specified by the allocation preferences 123, or by specifications for one or more specific payees included in the allocation preferences 123). In some embodiments, a payee may have a priority determined based on a size (absolute or relative to other accounts) of one or more accounts with the payee (past, present or projected future accounts), a length of a relationship with the payee (e.g., determined based on a date of a first account with the payee, such as a first account meeting a minimum size), and/or a priority ranking or score determined based on input from an external device (e.g., from a device associated with a user profile that includes the payee profiles 124).

The accounts 126 may include payee accounts 126a through 126n, and may include a projected account 130. The accounts 126 may be associated with a corresponding payee profile 124. In some embodiments, the profiling circuit 118 may determine that no payee profile (or an underdetermined payee profile) associated with the payee account 126a is available, and may generate a payee profile 124 associated with the payee account 126a. The accounts 126 may include any account related to the payee. For example, the accounts 126 may include commercial, business, or personal accounts, and may include payments or debts due to payees (e.g. vendors, suppliers, or creditors). In some embodiments, the accounts 126 include accounts due from payees to a party (e.g., to a user of the account management system associated with the accounts 126).

In some embodiments, the accounts 126 may include a payee account 126a. The payee account 126a may have a priority (e.g., a priority score). The payee account 126a may be assigned a priority score based on inputs received via a GUI provided by the user management circuit 116. The payee account 126a may have a priority based on a priority of the corresponding payee profile 124a. For example, the payee account 126a may have a priority score based on a priority score of the payee profile 124a. The priority score of the payee account 126a may be determined using operations that include assigning points to the priority score for the payee account 126a based on the priority score for the corresponding payee profile 124a.

In some embodiments, the accounts 126 may include a projected account 130. The projected account 130 includes projected financial accounts for a user profile managed by the user management circuit 116. The projected account 130 may reflect or include internal accounts for a party (e.g. a person, a corporation, a merchant, or a partnership), such as a current balance (e.g. of available funds, which may be accessible without cost), expected future expenses, and expected future incomes. For example, the projected account 130 may include a current cash on hand account, an upcoming tax expense, or an upcoming income such as an expected or projected revenue or third party investment. The projected account 130 may include or indicate an available amount of funds for payments made to one or more of the accounts 126. The projected accounts 130 may be determined by the profiling circuit 118 (e.g. based on parsing historical or current invoice data to determine previous expenses). The projected accounts 130 may be determined to cover at least the previous expenses, and may include a predetermined buffer amount to cover potential variation in the corresponding expenses. The projected accounts 130 may be based on a subset of invoices corresponding to a current date or time of calendar year (e.g., fiscal quarter), such as a past year's same fiscal quarter, to better determine the projected accounts 130.

In some embodiments, the projected account 130 may include a projected inventory supply account (e.g. a projected expense for inventory resupply). For example, an inventory resupply projected account 130 may be determined by the profiling circuit 118 based on invoice data for past inventory resupply (e.g. based on an invoice received from an inventory supplier), or based on past payments for inventory resupply. For example, the profiling circuit 118 may parse past invoice data from parties or accounts flagged as “inventory suppliers” or the like, and may determine an inventory resupply projected account 130 based on (e.g., that at least matches) the past payments to the inventory suppliers.

In some embodiments, the profiling circuit 118 may determine the inventory resupply projected account 130 based on current inventory supply. For example, the profiling circuit 118 may access current inventory data, and may determine the projected account 130 to be at least equal to a cost of bringing current inventory supplies up to a predetermined level from a current level. The profiling circuit 118 may determine a desired number of units of a type of inventory to achieve at least the predetermined level, may determine a price per unit (e.g. based on historical invoice data), and may accordingly determine the projected account 130 to be at least equal to the cost of purchasing the desired number of units.

The projected account 130 may be associated with a priority. In some embodiments, the projected account 130 may have a priority based on a category or type of the projected account. For example, a payroll expense may have a high priority, while a real estate related expense may have a low priority. In some embodiments, the projected account 130 may have a priority based on a cost of delayed payment of the projected account. The projected account 130 may have a priority based on input from a payor (e.g., via a GUI provided by the user management circuit 116). In some embodiments, the payor may directly set a priority score for the payor, or may input information about the projected account 130 upon which the priority score is based.

In some embodiments, the priority of the projected account 130 may indicate rules for managing the projected account 130. For example, the priority may indicate whether the projected account 130 is a high priority or a low priority, where high priority projected accounts 130 (or other allocation options) are addressed (e.g., funds are allocated to settle accounts in full or in part, or to have savings or a reserve of funds sufficient to address at least a portion of projected expenses) prior to low priority projected accounts 130 (or other allocation options). In some embodiments, the rules indicate that the high priority projected account 130 are to be fully addressed (e.g., funds are saved or reserved to settle the projected account 10 in full prior to addressing low priority allocation options). For example, a payor may specify via such rules that certain projected accounts 130 including payroll expenses are high priority, that certain pending payee accounts are low priority, and that the payroll expenses must be addressed in full prior to allocating funds to the payee accounts.

By way of further example, the priority for a projected account 130 may be a “must-pay” priority indicating that the projected account 130 must be addressed at a certain deadline (e.g., at a first deadline) for payment, and indicating that payments should not be delayed (e.g. past the first deadline). In some embodiments, the “must-pay” priority is a hard rule indicating that the projected account 130 must be paid at the deadline.

The projected account 130 may also include, in some embodiments, information regarding available sources of credit. For example, the projected account 130 may include information specifying an available credit amount (e.g. from a line of credit) and any associated borrowing costs. The projected account 130 may also include information specifying discrete borrowing times associated with the available source of credit.

The user management circuit 116 may provide for managing a user profile. The user profile may include the allocation preferences 123, the payee profiles 124 and the accounts 126. The allocation preferences 123, the payee profiles 124 and the accounts 126 included in the user profile managed by the user management circuit 116 may reflect or include preferences, or accounts owed by, due to, or projected for, one or more parties (e.g., one or more persons, corporations, merchants, or partnerships), which may be, for example, the user or parties represented by the user or on whose behalf the user acts. The user management circuit 116 may provide the user access to at least certain functionalities of the account management system 104. The user management circuit 116 may provide for communicating with the account management system 104. For example, the user management system may provide information (e.g. including data stored in the memory 114) to an external device (e.g. a device operated by the user). The information may include notifications, alerts, or messages. The information may also include graphical user interface (GUI) data for generating, rendering or accessing a GUI. The user management circuit 116 may provide the GUI (e.g. by providing the GUI data) to the external device, and the user management circuit 116 may receive inputs from the external device via the GUI. For example, the user management circuit 116 may receive credentials from the external device, and may provide access to the user profile responsive to verifying the user credentials.

The user management circuit 116 may also receive from the external device input regarding allocation preferences 123. For example, the user management circuit 116 may provide to the external device a GUI that includes a selectable object for selecting or setting any of the allocation preferences described herein. GUI may provide for selecting or setting allocation preferences 123 including prioritization preferences, credit preferences, and investment preferences.

In some embodiments, the user management circuit 116 may receive from the external device input regarding a priority of a payee. For example, the user management circuit 116 may provide to the external device a GUI that includes a selectable object for selecting or setting a priority score or rank for a payee, for an account (e.g. for a payee account or for a projected account). The GUI may allow setting a priority (e.g., on a 5 point scale, on a 10 point scale, on a 100 point scale, or on another scale) via a slider, via an input field, or via another selectable object. The GUI may allow setting a priority to “high” or “low”, or to “must-pay” as described herein. The GUI may allow setting category points for categories of allocation options (e.g., that can be used in determining aggregate priority scores for allocation options). This can provide for customizing a payee or an account's importance.

In some embodiments, GUI may provide for specifying that a particular category of payment deadline (e.g. a first deadline, second deadline, minimum payment deadline, or other deadline) should never be missed or should only be missed when certain conditions are met (e.g., the GUI may display, in a selectable manner, one or more deadlines, and a selected deadline may be set as a deadline that should never be missed or should only be missed when certain conditions are met). The profiling circuit 118 can process this information to determine the priority for the account or for the payee.

The user management circuit 116 may also receive via the GUI input regarding payment rules (e.g., for accounts or for a payee). Such payment rule information may include specifications of any payment rule information, including deadlines and any associated delayed payment costs. The payment rule information may be received via a GUI provided by the user management circuit 116 that includes one or more selectable objects for specifying the payment rule information. For example, the GUI may provide for selecting a payee or an account (or a category of payee or a category of accounts), and may responsively provide a payment rule screen, menu, or wizard that allows setting corresponding payment rules. The GUI may allow for setting payment rules and associating conditions with the payment rules. For example, the GUI may allow selecting a rule that specifies that a payee or account (or a category of payee or account) is to be paid when certain conditions are met (or is not to be paid unless certain conditions are met), and the GUI may provide for selecting conditions (e.g., from a list of predetermined conditions). The conditions may include having addressed one or more accounts or payees of a certain priority (e.g., having a higher priority than the account or payee associated with the conditions being set), or having sufficient savings or a reserve of funds (e.g., sufficiency being enough to cover one or more projected accounts, and may include enough to provide a predetermined or user-selected buffer).

The user management circuit 116 may also receive via the GUI input regarding accounts. For example, information regarding payee accounts 126a and/or a projected account 130 may be received via the user management circuit 116 (e.g., via a GUI provided by the user management circuit 116). Such account information may include a user specified payment due to a payee, a regular or repeating payment due to a payee, and/or a current balance or one or more accounts or lines of credit. In some embodiments, the user management circuit 116 may be integrated with certain financial functions of a computing system (e.g. an invoicing, billing, or other financial management system) such that the user management circuit 116 receives the account information, or can request the account information from the computing system. For example, the computing system may be a system managed by the user or a party represented by the user (e.g. an internal financial management computer system of an individual, a corporation, a merchant, or a partnership). In some embodiments, the profiling circuit 118 parses invoice data to detect potential accounts (e.g., in any manner described herein), and the GUI presents the detected accounts to the user for confirmation of the detected accounts. Responsive to receiving a confirmation of a detected account via the GUI, the profiling circuit 118 may accordingly generate a payee accounts 126 or a projected account 130. The GUI may also allow the user to specify details of the generated account (e.g., in any manner described herein, such as by setting a priority score).

The user management circuit 116 may perform certain notification operations including transmitting a notification that funds are incoming, the funds are in need of allocating, that funds have been allocated, or that a payment is due. For example, the user management circuit 116 may transmit a notification that funds have been allocated. The notification may include or specify an amount of funds that have been allocated and allocation options to which the funds have been allocated. The notification may include a response option (e.g., a selectable object included in a GUI) that provides for transmitting a response to the notification to the account management system 104 via the user management circuit 116. The response may include, for example, an approval of the allocation of funds or of a portion of the allocation of funds (e.g. of one or more payments).

The profiling circuit 118 may provide for determining the user profile, the allocation preferences 123, the payee profiles 124, and/or the accounts 126. For example, the profiling circuit 118 may receive profile information via the user management circuit 116 (e.g. a selection of user credentials or payment information including one or more financial account numbers and/or a preferred payment method). The transaction management circuit may make use of the payment information to implement financial transactions via the financial computing system 102.

The profiling circuit 118 may determine or generate the payee profiles 124 and/or the accounts 126. For example, the profiling circuit 118 may determine the payment rules 128. The profiling circuit 118 may receive payment rule information via the user management circuit 116 (e.g., specifications for priorities, or for payment deadlines and any associated delayed payment costs), and may determine the payment rules 128 based on the received payment rule information. The profiling circuit 118 may also determine the priority for the payee based on priority information received via the user management circuit 116, and may determine the accounts 126 based on the account information received via the user management circuit 116.

The allocation management circuit 120 may provide for determining or generating an allocation of funds (e.g., for a user profile). The allocation of funds may include one or more payments to one or more payees, for one or more accounts 126, and/or payments or reserving funds for one or more projected accounts 130. The allocation management circuit 120 may determine one or more allocation options for the one or more payments.

In some embodiments, the allocation management circuit 120 may determine or generate an allocation of funds (e.g., for a user profile) responsive to a trigger. The trigger may include, for example, an indication that incoming funds have arrived, or will arrive (e.g., within a predetermined amount of time) at one or more accounts. The trigger may include an indication that one or more expenses are due, will be due (e.g., within a predetermined amount of time), or have been incurred. The indication may be determined by the allocation management circuit 120 based on one or more inputs (e.g., inputs received via the user management circuit 116). For example, the inputs may include invoices, receipts, or other business or financial documents or files (e.g., paper or electronic), and the allocation management circuit 120 may parse the inputs to determine whether an allocation of funds is triggered.

In some embodiments, the allocation options may be candidate allocation options or candidate allocations. In some embodiments, each allocation option may include a payment amount and a payment time. Each allocation option may include a payment source (e.g. from a particular financial account, from a credit source, or a combination thereof). The allocation option may include one or more payments, including for example a first payment (e.g. a minimum payment) and a subsequent second payment (e.g. for at least a portion of a remaining balance). The allocation option may specify making a payment on a latest discrete payment time in advance of a discrete payment time specified by payment rules. Thus, payments may be made as late as possible without incurring additional costs. The allocation option may specify borrowing from a credit source during a latest borrowing time in advance of a discrete payment time specified by payment rules. Thus, borrowing may be implemented as late as possible without incurring additional costs.

The allocation management circuit 120 may determine a first initial allocation option (e.g. a payment for a first account to a first payee from a funding source having, or projected to have, sufficient funds to pay the cost of the payment). The allocation management circuit 120 may determine a second dependent allocation option based on the first allocation option (e.g. a payment for a second account to a second payee (which may be the same as or different from the first payee) from a funding source having, or projected to have, sufficient funds to pay the cost of the payment, taking into account the first allocation option (e.g. a potential debit of the funding source)). The allocation management circuit 120 may proceed to determine additional allocation options (e.g. a third allocation option, a fourth allocation option, or more) in a similar fashion. The allocation management circuit 120 may thus determine a set of consistent allocation options for which all payments can be made given available and/or projected funding sources. The allocation management circuit 120 may determine a plurality of sets of allocation options having different initial allocation options based on which dependent allocation options are determined.

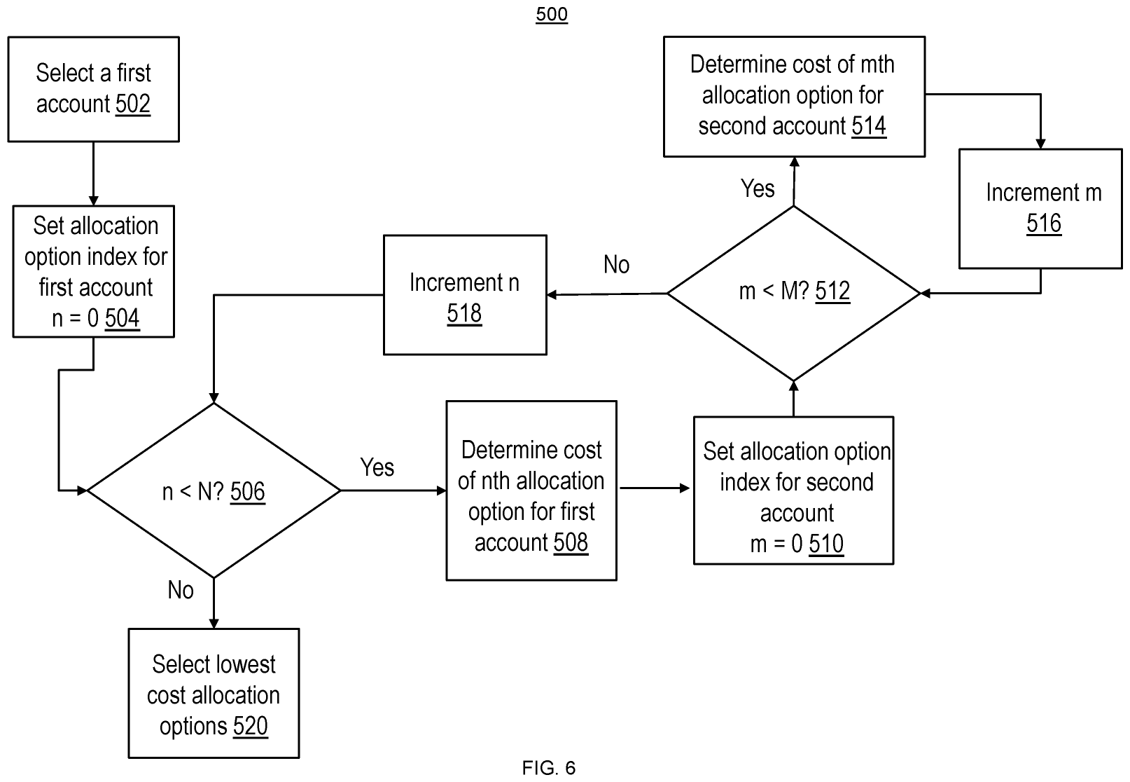

The allocation management circuit 120 may determine costs for the allocation options. The costs for the allocation options may reflect a total cost (e.g. including a base cost to be paid for an account 126 and delayed payment costs), or may reflect delayed payment costs (e.g. including the delayed payment costs and not including the base cost). The determined costs may be used to compare costs of sets of allocation options. An example implementation of such a method is shown in FIG. 6.

In some embodiments, the allocation management circuit 120 is configured to compare a cost of delayed payment to a cost of borrowing from a credit source. The allocation management circuit 120 may determine the cost of an allocation option using operations that include replacing any delayed payment costs that exceed a cost of borrowing from the credit source with the cost of borrowing from the credit source (e.g. interest due for the borrowing). This can provide for determining an allocation of funds that makes use of available credit sources when appropriate (e.g. when it results in a lower cost than would otherwise be the case). In some embodiments, the allocation management circuit 120 is configured to determining a cost reduction opportunity (e.g. repayment of a loan) or an investment opportunity (e.g. with an expected or projected return), and to compare the delayed payment cost the first option to a cost of not realizing the cost reduction opportunity or the investment opportunity. In some embodiments the allocation management circuit 120 may determine the cost of an allocation option using operations that include reducing a delayed payment costs by the expected or projected return.

The allocation management circuit 120 may generate an allocation of funds based on the projected account 130, the cost for a first allocation option, and the cost for a second allocation option. The allocation of funds may specify one or more financial transactions for making payments included in the allocation of funds (e.g., may specify sources and destinations for funds being transferred). The allocation of funds may be implemented by the financial computing system 102 (e.g. at the request of the transaction management circuit 122).

The transaction management circuit 122 may perform certain payment resolution operations including transferring funds, or causing funds to be transferred, to resolve the payment. The transaction management circuit 122 may implement an allocation of funds or a portion of an allocation of funds generated by the allocation management circuit 120. The transaction management circuit 122 receive approval for the implementation of the allocation of funds prior to implementing the allocation of funds. For example, the account management system 104 may receive approval of an allocation of funds responsive to a notification transmitted by the allocation management circuit 120. The approval may include payment information (such as an account number) and/or security credentials that can be checked (either by the account management system 104 or by the financial computing system 102) to implement a security protocol. In some embodiments, the transaction management circuit 122 may receive the approval from a party, and may retrieve account information corresponding to the party (e.g. financial account information, or user information for a financial account) stored locally. The transaction management circuit 122 may transmit a financial transaction request to the financial computing system 102 for processing by the account management circuit 110, the financial transaction request including any of the payment information, the security credentials, the account information, or a party identification, as well as payment information including an amount of funds to be transferred, account information for an account to be debited, account information for an account to be credited, and fund routing information. The account management circuit 110 may implement the requested transaction and notify the transaction management circuit 122, which may in turn instruct the user management circuit 116 to transmit a notification of resolution of the allocation of funds or portion of the allocation of funds to appropriate parties.

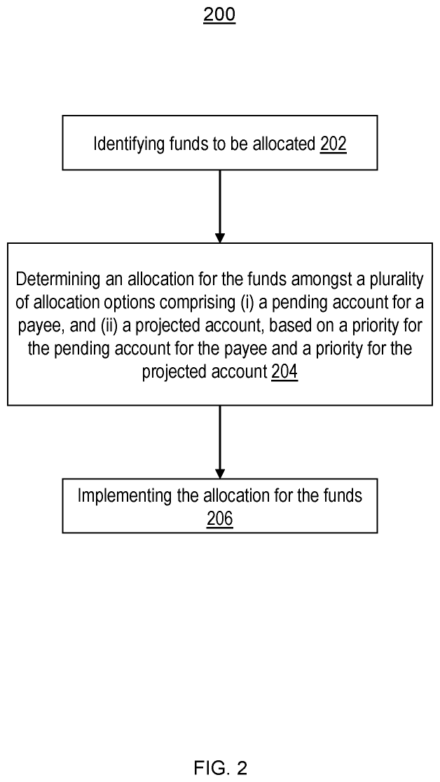

Referring now to FIG. 2, FIG. 2 is a flowchart of an example method 200 for allocating funds that can be executed by the account management system 104, according to an example embodiment. The method includes blocks 202 through 206. In a brief overview, at block 202, the account management system 104 may identify funds to be allocated. At block 204, the account management system 104 may determine an allocation for the funds amongst a plurality of allocation options comprising (i) a pending account for a payee, and (ii) a projected account, based on a priority for the pending account for the payee and a priority for the projected account. At block 206, the account management system 104 may implement the allocation for the funds.

In more detail, at block 202, the account management system 104 may identify funds to be allocated. In some embodiments, the allocation management circuit 120 may determine the funds to be allocated responsive to a trigger. The trigger may include, for example, an indication that incoming funds have arrived, or will arrive (e.g., within a predetermined amount of time) at one or more accounts. The trigger may include an indication that one or more expenses are due, will be due (e.g., within a predetermined amount of time), or have been incurred. The indication may be determined by the allocation management circuit 120 based on one or more inputs (e.g., inputs received via the user management circuit 116). For example, the inputs may include invoices, receipts, or other business or financial documents or files (e.g., paper or electronic), and the allocation management circuit 120 may parse the inputs to determine whether an allocation of funds is triggered.

At block 204, the account management system 104 may determine an allocation for the funds amongst a plurality of allocation options comprising (i) a pending account for a payee, and (ii) a projected account, based on a priority for the pending account for the payee and a priority for the projected account. The pending account for a payee may be a payee account 126a corresponding to a payee profile 124. The payee may be a vendor, for example, and the payee account may be a payment owed to the vendor. The projected account may be a projected account 130, and may be, for example, a payroll expense.

The payee account 126a and the projected account 130 may be allocation options having respective priorities. For example, each priority may be a priority score. The priority may indicate rules for the allocation option. For example, the priority may indicate whether the allocation option is a high priority or a low priority. The allocation options may be assessed in terms of allocation preferences 123 (and/or rules regarding allocation), that may specify the high priority allocation options are addressed (e.g., funds are allocated to settle accounts in full or in part, or to have savings or a reserve of funds sufficient to address at least a portion of projected expenses) prior to the low priority allocation options. In some embodiments, the allocation preferences 123 indicate that the high priority allocation options are to be fully addressed (e.g., funds are allocated to settle accounts in full, or to have savings or a reserve of funds sufficient to completely cover projected expenses) prior to addressing any low priority allocation options. For example, a payor may specify via such rules that certain projected expenses including payroll expenses are high priority, that certain pending payee accounts are low priority, and that the payroll expenses must be addressed in full prior to allocating funds to the payee accounts.

At block 206, the account management system 104 may implement the allocation for the funds. For example, the account management system 104 may transmit, to a financial computing system, a request to implement the one or more financial transactions. This may include the transaction management circuit 122 transferring funds, or causing funds to be transferred, to resolve the payment. The transaction management circuit 122 may implement an allocation of funds or a portion of an allocation of funds generated by the allocation management circuit 120. The transaction management circuit 122 receive approval for the implementation of the allocation of funds prior to implementing the allocation of funds. For example, the account management system 104 may receive approval of an allocation of funds responsive to a notification transmitted by the allocation management circuit 120. The approval may include payment information (such as an account number) and/or security credentials that can be checked (either by the account management system 104 or by the financial computing system 102) to implement a security protocol. In some embodiments, the transaction management circuit 122 may receive the approval from a party, and may retrieve account information corresponding to the party (e.g. financial account information, or user information for a financial account) stored locally. The transaction management circuit 122 may transmit a financial transaction request to the financial computing system 102 for processing by the account management circuit 110, the financial transaction request including any of the payment information, the security credentials, the account information, or a party identification, as well as payment information including an amount of funds to be transferred, account information for an account to be debited, account information for an account to be credited, and fund routing information. The account management circuit 110 may implement the requested transaction and notify the transaction management circuit 122, which may in turn instruct the user management circuit 116 to transmit a notification of resolution of the allocation of funds or portion of the allocation of funds to appropriate parties.

Thus, the account management system 104 may effectively allocated funds according to a prioritization scheme to achieve improved fund allocation.

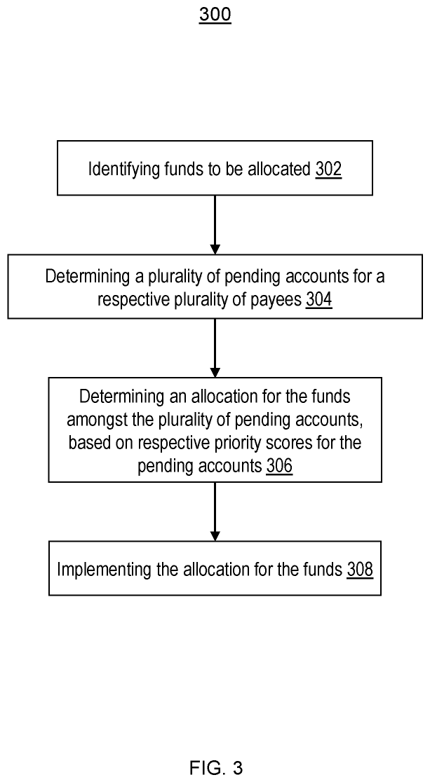

Referring now to FIG. 3, FIG. 3 is a flowchart of an example method 300 for allocating funds that can be executed by the account management system 104, according to an example embodiment. The method includes blocks 302 through 308. In a brief overview, at block 302, the account management system 104 may identify funds to be allocated. At block 304, the account management system 104 may determine a plurality of pending accounts for a respective plurality of payees. At block 306, the account management system 104 may determine an allocation for the funds amongst the plurality of pending accounts, based on respective priority scores for the pending accounts. At block 308, the account management system 104 may implement the allocation for the funds.

In more detail, at block 302, the account management system 104 may identify funds to be allocated. In some embodiments, the allocation management circuit 120 may determine the funds to be allocated responsive to a trigger. The trigger may include, for example, an indication that incoming funds have arrived, or will arrive (e.g., within a predetermined amount of time) at one or more accounts. The trigger may include an indication that one or more expenses are due, will be due (e.g., within a predetermined amount of time), or have been incurred. The indication may be determined by the allocation management circuit 120 based on one or more inputs (e.g., inputs received via the user management circuit 116). For example, the inputs may include invoices, receipts, or other business or financial documents or files (e.g., paper or electronic), and the allocation management circuit 120 may parse the inputs to determine whether an allocation of funds is triggered.

At block 304, the account management system 104 may determine a plurality of pending accounts for a respective plurality of payees. The accounts may be payee accounts 126a. In some embodiments, the allocation management circuit 120 may determine a subset of the payee accounts 126a based on respective priorities of the payee accounts, or based on payment deadlines for the payee accounts. For example, the allocation management circuit 120 may determine the subset of the payee accounts 126a having priorities above a reference threshold, or may determine the subset of the payee accounts 126a having deadlines within a predetermined timeframe (e.g. a deadline on or before a predetermined date).

At block 306, the allocation management circuit 120 may determine an allocation for the funds amongst the plurality of pending accounts, based on respective priority scores for the pending accounts. The pending accounts may be assessed in terms of allocation preferences 123 (and/or rules regarding allocation). For example, the allocation preferences 123 may specify that high priority allocation options are addressed (e.g., funds are allocated to settle accounts in full or in part, or to have savings or a reserve of funds sufficient to address at least a portion of projected expenses) prior to low priority allocation options. In some embodiments, the allocation preferences 123 indicate that the high priority allocation options are to be fully addressed (e.g., funds are allocated to settle accounts in full, or to have savings or a reserve of funds sufficient to completely cover projected expenses) prior to addressing any low priority allocation options. In some embodiments, one or more of the payee accounts 126a may have a “must-pay” priority, and the allocation management circuit 120 may determine an allocation that includes payment to the must-pay payees.

At block 308, the account management system 104 may implement the allocation for the funds, such as in a manner similar to that described above with respect to block 206 of the method 200.

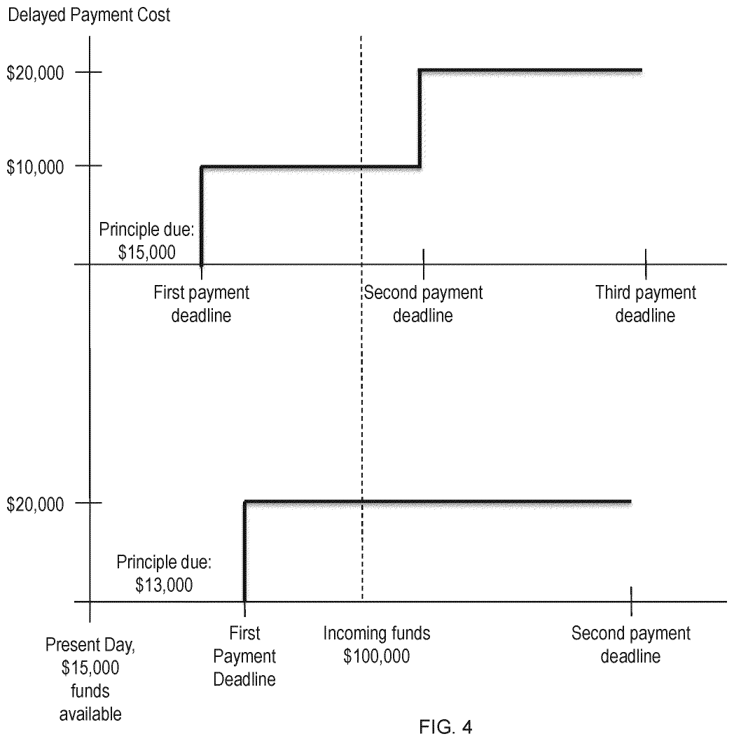

Referring now to FIG. 4, FIG. 4 is a graph showing accounts and payment rules, according to an example embodiment. The accounts and payment rules shown in FIG. 4 may be referred to herein as the “FIG. 4 example.” In the FIG. 4 example, a projected account 130 specifies that at present, $15,000 of funding is available for payments, and that at a future date (indicated by a dashed line) incoming funds of $100,000 will become available. FIG. 4 shows two payee accounts: a first account (top) and a second account (bottom). The first account is for $15,000 that is associated with payment rules that specify a first payment deadline, a second payment deadline, and third payment deadline. The $15,000 is due in advance of the first payment deadline. Following failure to pay by the first payment deadline, delayed payment costs of $10,000 will be accrued. Following failure to pay by the second payment deadline, additional delayed payment costs of $10,000 will be accrued (for a total of $20,000 delayed payment costs). The third payment deadline is an unextendible deadline at which payment must be made.

FIG. 4 also shows a second account for $13,000 that is associated with payment rules that specify a first payment deadline and a second payment deadline. The $13,000 is due in advance of the first payment deadline. Following failure to pay by the first payment deadline, delayed payment costs of $20,000 will be accrued. The second payment deadline is an unextendible deadline at which payment must be made.

In the FIG. 4 example, given the projected income of $100,000 at a future date, at that date there will be sufficient funding to pay accounts being analyzed and any delayed payment costs. However, at present there is only funding to pay one of the first account and the second account, and a decision should be made as to when to pay which accounts. The systems and methods provided herein, including the account management system 104, can provide for determining an allocation of funds that minimizes or reduces costs by selectively making payments at specific dates based on costs (e.g. based on delayed payment costs). The allocation management circuit 120 may determine a first set of allocation options including a first allocation option of paying the first account in advance of the first deadline, and a second allocation option based on the first allocation option (e.g. based on the lack of funds available to pay the second account in advance of the first deadline) to pay the second account by the second deadline. The allocation management circuit 120 may determine costs for the first set of allocation options (e.g., $20,000 in delayed payment costs).

The allocation management circuit 120 may also determine a second set of allocation options including a first allocation option of paying the second account in advance of the first deadline, and a second allocation option based on the first allocation option (e.g. based on the lack of funds available to pay the first account in advance of the first deadline) to pay the first account by the second deadline. The allocation management circuit 120 may determine costs for the first set of allocation options (e.g., $10,000 in delayed payment costs).

The allocation management circuit 120 may compare the costs of the first set of allocation options and the second set of allocation options, and may select a lowest cost set of allocation options for inclusion in an allocation of funds. In the present example, the allocation management circuit 120 may select the second set of allocation options having a delayed payment costs of $10,000. Thus, the allocation management circuit 120 may determine an allocation of funds that reduces or minimizes costs.

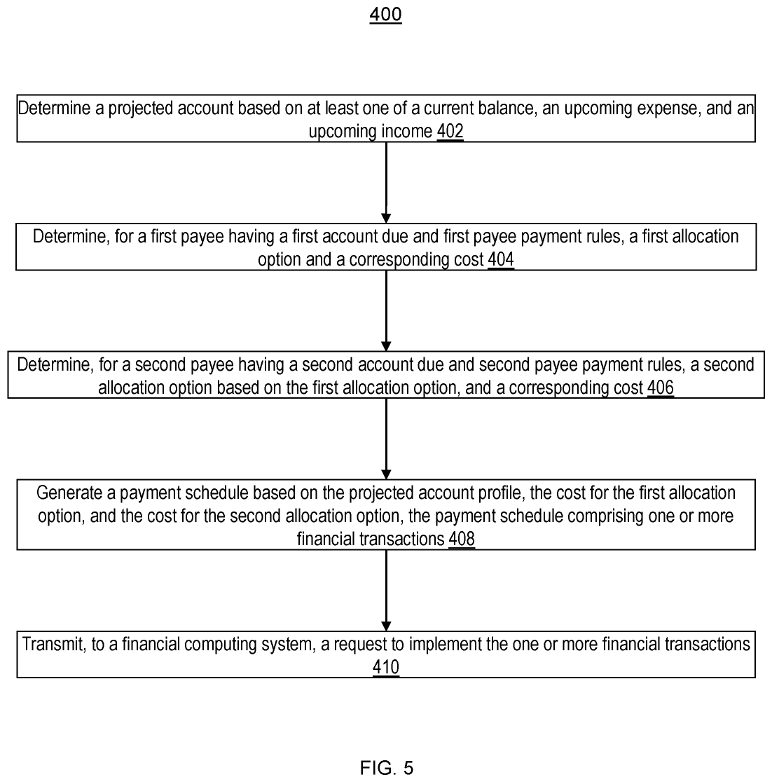

Referring now to FIG. 5, FIG. 5 is a flowchart of an example method 400 for managing accounts that can be executed by the account management system 104, according to an example embodiment. The method includes blocks 402 through 410. In a brief overview, at block 402, the account management system 104 may determine a projected account based on at least one of a current balance, an upcoming expense, and an upcoming income. At block 404, the account management system 104 may determine, for a first payee having a first account due and first payee payment rules, a first allocation option and a corresponding cost. At block 406, the account management system 104 may determine, for a second payee having a second account due and second payee payment rules, a second allocation option based on the first allocation option, and a corresponding cost. At block 408, the account management system 104 may generate an allocation of funds based on the projected account, the cost for the first allocation option, and the cost for the second allocation option, the allocation of funds comprising one or more financial transactions. At block 410, the account management system 104 may transmit, to a financial computing system, a request to implement the one or more financial transactions.

In more detail, at block 402, the account management system 104 may determine a projected account based on at least one of a current balance, an upcoming expense, and an upcoming income. The projected account 130 includes projected financial accounts for a user profile managed by the user management circuit 116. The projected account 130 may reflect or include internal accounts for a party (e.g. a person, a corporation, a merchant, or a partnership), such as a current balance (e.g. of available funds, which may be accessible without cost), expected future expenses, and expected future incomes. For example, the projected account 130 may include a current cash on hand account, an upcoming payroll expense, or an upcoming income such as an expected or projected revenue or third party investment. The projected account 130 may include or indicate an available amount of funds for payments made to one or more of the accounts 126.

The projected account 130 may also include, in some embodiments, information regarding available sources of credit. For example, the projected account 130 may include information specifying an available credit amount (e.g. from a line of credit) and any associated borrowing costs. The projected account 130 may also include information specifying discrete borrowing times associated with the available source of credit.

The profiling circuit 118 may receive information (e.g., any of the information discussed above) regarding the projected account 130 via the user management circuit 116, and may determine the projected account 130 accordingly. In some embodiments, the user management circuit 116 may be integrated with certain financial functions of a computing system (e.g. an invoicing, billing, or other financial management system) such that the user management circuit 116 receives the account information, or can request the account information from the computing system. For example, the computing system may be a system managed by the user or a party represented by the user (e.g. an internal financial management computer system of an individual, a corporation, a merchant, or a partnership).

At block 404, the account management system 104 may determine, for a first payee having a first account due and first payee payment rules, a first allocation option and a corresponding cost. At block 406, the account management system 104 may determine, for a second payee having a second account due and second payee payment rules, a second allocation option based on the first allocation option, and a corresponding cost. The allocation management circuit 120 may determine a first initial allocation option (e.g. a payment for a first account to a first payee from a funding source having, or projected to have, sufficient funds to pay the cost of the payment). The allocation management circuit 120 may determine a second dependent allocation option based on the first allocation option (e.g. a payment for a second account to a second payee (which may be the same as or different from the first payee) from a funding source having, or projected to have, sufficient funds to pay the cost of the payment, taking into account the first allocation option (e.g. a potential debit of the funding source)). The allocation management circuit 120 may proceed to determine additional allocation options (e.g. a third allocation option, a fourth allocation option, or more) in a similar fashion. The allocation management circuit 120 may thus determine a set of consistent allocation options for which all payments can be made given available and/or projected funding sources. The allocation management circuit 120 may determine a plurality of sets of allocation options having different initial allocation options based on which dependent allocation options are determined.

At block 408, the account management system 104 may generate an allocation of funds based on the projected account, the cost for the first allocation option, and the cost for the second allocation option, the allocation of funds comprising one or more financial transactions. This may include the allocation management circuit 120 comparing a cost of delayed payment to a cost of borrowing from a credit source. The allocation management circuit 120 may determine the cost of an allocation option using operations that include replacing any delayed payment costs that exceed a cost of borrowing from the credit source with the cost of borrowing from the credit source (e.g. interest due for the borrowing). This can provide for determining an allocation of funds that makes use of available credit sources when appropriate (e.g. when it results in a lower cost than would otherwise be the case). In some embodiments, the allocation management circuit 120 is configured to determining a cost reduction opportunity (e.g. repayment of a loan) or an investment opportunity (e.g. with an expected or projected return), and to compare the delayed payment cost the first option to a cost of not realizing the cost reduction opportunity or the investment opportunity. In some embodiments the allocation management circuit 120 may determine the cost of an allocation option using operations that include reducing a delayed payment costs by the expected or projected return. The allocation management circuit 120 may generate an allocation of funds by selecting one or more lowest cost allocation options for inclusion in the allocation of funds.

At block 410, the account management system 104 may transmit, to a financial computing system, a request to implement the one or more financial transactions. This may include the transaction management circuit 122 transferring funds, or causing funds to be transferred, to resolve the payment. The transaction management circuit 122 may implement an allocation of funds or a portion of an allocation of funds generated by the allocation management circuit 120. The transaction management circuit 122 receive approval for the implementation of the allocation of funds prior to implementing the allocation of funds. For example, the account management system 104 may receive approval of an allocation of funds responsive to a notification transmitted by the allocation management circuit 120. The approval may include payment information (such as an account number) and/or security credentials that can be checked (either by the account management system 104 or by the financial computing system 102) to implement a security protocol. In some embodiments, the transaction management circuit 122 may receive the approval from a party, and may retrieve account information corresponding to the party (e.g. financial account information, or user information for a financial account) stored locally. The transaction management circuit 122 may transmit a financial transaction request to the financial computing system 102 for processing by the account management circuit 110, the financial transaction request including any of the payment information, the security credentials, the account information, or a party identification, as well as payment information including an amount of funds to be transferred, account information for an account to be debited, account information for an account to be credited, and fund routing information. The account management circuit 110 may implement the requested transaction and notify the transaction management circuit 122, which may in turn instruct the user management circuit 116 to transmit a notification of resolution of the allocation of funds or portion of the allocation of funds to appropriate parties.

Referring now to FIG. 6, FIG. 6 is a flowchart of an example method 500 for selecting allocation options that can be executed by the account management system 104, according to an example embodiment. The example method for selecting allocation options described above in reference to FIG. 5 is a specific example of the more general method 500 shown in FIG. 6. FIG. 6 shows the method 500 of selecting allocation options for an allocation of funds that includes calculating payments cost for sets of allocation options. The method 500 may determine a lowest cost set of payments options exhaustively, by considering many or all possible combinations of allocation options, or may consider a smaller number of payments options. The method 500 may implement algorithms for selecting certain allocation options to consider, which can result in a method that provides a faster result. Other embodiments may not exhaustively consider allocation options.

The method includes blocks 502 through 514. At block 502, the allocation management circuit 120 may select a first account of the accounts 126. At block 504, the allocation management circuit 120 may initialize an allocation option index n for the first account (e.g. set to n=0). The allocation option index can index a predetermined number N allocation options for the first account (e.g. including allocation options having different payment dates and/or different payment amounts). At block 506, the allocation management circuit 120 may determine whether the current value of the allocation option index for the first account is less than the predetermined number N. If not, the method proceeds to block 520, described below. If so, the method proceeds to block 508.

At block 508, the allocation management circuit 120 may determine a cost of the nth allocation option for the first account. At block 510, the allocation management circuit 120 may initialize an allocation option index m for a second account (e.g. set to m=0). The allocation option index can index a predetermined number M allocation options for the second account (e.g. including allocation options having different payment dates and/or different payment amounts). At block 512, the allocation management circuit 120 may determine whether the current value of the allocation option index for the second account is less than the predetermined number M. If not, the method proceeds to block 518, described below. If so, the method proceeds to block 514.

At block 514, the allocation management circuit 120 may determine a cost of the mth allocation option for the second account. At block 516, the allocation management circuit 120 may increment the allocation option index for the second account m, and the method returns to block 512. When m is not less than M, all M second allocation options have been considered, and the method proceeds to block 518. At block 518, the allocation management circuit 120 may increment the allocation option index for the first account n, and the method may return to block 506. When n is not less than N, all N first allocation options have been considered, and the method proceeds to block 520.

At block 520, the allocation management circuit 120 may select lowest cost allocation options. The allocation management circuit 120 may compare the costs of sets of allocation options determined in preceding blocks, and may select a lowest cost set of allocation options for inclusion in an allocation of funds. Thus, an allocation of funds that minimizes or reduces costs may be provided.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

In embodiments described herein, one or more processors may execute instructions stored in memory or may execute instructions otherwise accessible to the one or more processors. Reference to “a processor” made herein can refer to a single processor, or to a plurality of processors that are communicatively coupled. The plurality of processors need not be located in proximity to each other or at a same facility. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In some example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc.

An example system for implementing the overall system or portions of the embodiments might include general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAIVI, magnetic storage, hard discs, optical discs, etc. In some embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, a touch screen, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (including, for example, cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A method for managing accounts using an account management system comprising an allocation management circuit and a transaction management circuit, the method comprising:
identifying, by the allocation management circuit, funds to be allocated;
determining, by the allocation management circuit, an allocation for the funds amongst a plurality of allocation options comprising (i) a pending account for a payee, and (ii) a projected account, based on a priority for the pending account for the payee and a priority for the projected account; and
implementing, by the transaction management circuit, the allocation for the funds.

2. The method of claim 1, wherein the account management system further comprises a profiling circuit, the method further comprising:
determining, by the profiling circuit, a priority score for the payee; and
determining, by the profiling circuit, a priority score for the pending account for the payee by operations including assigning points to the priority score for the pending account for the payee based on the priority score for the payee, wherein
determining the allocation for the funds comprises comparing the priority score for the pending account for the payee to a reference threshold.

3. The method of claim 1, wherein the account management system further comprises a profiling circuit, the method further comprising:
determining, by the profiling circuit, a priority score for the pending account for the payee by assigning points to the priority score for the pending account based on an account type of the pending account, or based on an amount owed for the pending account, wherein
determining the allocation for the funds comprises comparing the priority score for the pending account for the payee to a reference threshold.

4. The method of claim 1, wherein the priority of the pending account for the payee includes a first priority score and the priority of the projected account includes a second priority score, the method further comprising:
determining, by the allocation management circuit, which of the first priority score and the second priority score is higher; and
allocating, by the allocation management circuit, funds to the account having the higher of the first priority score and the second priority score.

5. The method of claim 4, further comprising allocating, by the allocation management circuit, remaining funds of the funds to be allocated to the account having the lower of the first priority score and the second priority score subsequent to allocating funds to the account having the higher of the first priority score and the second priority score.

6. The method of claim 1, wherein the account management system further comprises a user management circuit, the method further comprising:
providing, by the user management circuit, a graphical user interface;
receiving, via the graphical user interface, a priority score for the projected account; and
determining the priority for the pending account based on the received priority score, wherein
determining the allocation for the funds comprises determining whether to allocate funds to the pending account based on the determined priority.

7. The method of claim 1, wherein the account management system further comprises a user management circuit, the method further comprising:
providing, by the user management circuit, a graphical user interface;
receiving, via the graphical user interface, an input indicating that the priority of the projected account is a must-pay priority; and
setting the priority of the projected account to the must-pay priority, wherein
determining the allocation for the funds comprises determining to allocate funds to the projected account based on the must-pay priority.

8. The method of claim 1, wherein the account management system further comprises a profiling circuit, the method further comprising:
determining, by the allocation management circuit, a cost of delayed payment of the projected account; and
determining, by the profiling circuit, a priority score as the priority for the projected account, based on the cost of delayed payment of the projected account, wherein
determining the allocation for the funds comprises comparing the priority score to a reference threshold.

9. The method of claim 1, wherein the account management system further comprises a profiling circuit, the method further comprising:
parsing, by the profiling circuit, invoice data to identify the payee and the amount of the pending account for the payee; and
determining, by the profiling circuit, a priority score for the pending account for the payee based on the amount of the pending account, wherein
determining the allocation for the funds comprises comparing the priority score for the pending account for the payee to a reference threshold.

10. A method for managing accounts using an account management system comprising one or more processors, the method comprising:
identifying, by the one or more processors, funds to be allocated;
determining, by the one or more processors, a plurality of pending accounts for a respective plurality of payees;
determining, by the one or more processors, an allocation for the funds amongst the plurality of pending accounts, based on respective priority scores for the pending accounts; and
implementing, by the one or more processors, the allocation for the funds.

11. The method of claim 10, further comprising:
determining, by the one or more processors, a projected account based on at least one of a current balance, an upcoming expense, and an upcoming income;
determining, by the one or more processors, for a first payee of the plurality of payees having a first pending account and first payee payment rules, a first allocation option and a corresponding cost based on the first payee payment rules;
determining, by the one or more processors, for a second payee having a second pending account and second payee payment rules, a second allocation option based on the first allocation option, and a corresponding cost based on the second payee payment rules; and
generating, by the one or more processors, a payment schedule based on the projected account, the cost for the first allocation option, and the cost for the second allocation option, the payment schedule comprising one or more financial transactions,
wherein the determined allocation of funds includes the payment schedule, and the one or more processors implement the allocation of funds according to the payment schedule.

12. The method of claim 11, further comprising:
providing, by the one or more processors, a graphical user interface;
receiving, by the one or more processors via the graphical user interface, inputs specifying the first payee and relating to payment rules for the first payee; and
generating, by the one or more processors, the payment rules for the first payee based on the inputs for reference in determining the cost of the first allocation option.

13. The method of claim 11, wherein the first allocation option for the first payee comprises a first payment and a second payment, the first payment is a minimum payment specified by the payment rules for the first payee, the second payment is a delayed payment, and determining the cost corresponding to the first allocation option comprises determining a cost of the delayed payment.

14. The method of claim 13, wherein determining the second allocation option based on the first allocation option comprises determining to allocate funds to the first pending account for the minimum payment, and determining to allocate remaining funds to the second pending account.

15. A system for managing accounts, comprising:
a processor; and
a data storage medium storing processor-executable instructions that, when executed by the processor, cause the processor to:
identify funds to be allocated;
determine an allocation for the funds amongst a plurality of allocation options comprising (i) a pending account a payee, and (ii) a projected account, based on a priority for the pending account for the payee and a priority for the projected account; and
implement the allocation for the funds.

16. The system of claim 15, wherein the allocation options include an investment opportunity having a priority, and determining the allocation for the funds further comprises allocating funds to the allocation option having the highest priority.

17. The system of claim 15, wherein:
the allocation options include an investment opportunity,
the data storage medium stores investment preferences that specify allocating funds for the investment opportunity only if the priority of the pending account for the payee is below a reference threshold, and
determining the allocation for the funds comprises comparing the priority of the pending account for the payee to the reference threshold to determine whether to allocate funds to the investment opportunity.

18. The system of claim 15, wherein:
the allocation options include an investment opportunity,
the data storage medium stores investment preferences that specify allocating funds for the investment opportunity if a delayed payment cost for the pending account for the payee is below a reference threshold, and
determining the allocation for the funds comprises comparing the delayed payment cost for the pending account for the payee to the reference threshold to determine whether to allocate funds to the investment opportunity.

19. The system of claim 18, further comprising determining a projected return from the investment opportunity, wherein the reference threshold referenced to determine whether to allocate funds to the investment opportunity is based on the projected return from the investment opportunity.

20. The system of claim 19, wherein the investment opportunity is a cost reduction opportunity to pay down an interest-bearing account, and determining the projected return comprises calculating savings on interest payments due to paying down the interest-bearing account.
